(19) United States
(12) Patent Application Publication
(10) Pub. No.: US 2005/0260539 A1
(43) Pub. Date: Nov. 24, 2005

(54) DISPOSABLE ADHESIVE DELIVERY PAD FOR DENTAL ARTICLES

(76) Inventor: Theodore P. Croll, Mechanicsville, PA (US)

Correspondence Address: GREGORY J. GORE, 70 WEST OAKLAND AVENUE, SUITE 316, DOYLESTOWN, PA, 18901, US

(21) Appl. No.: 11/161,557

(22) Filed: Aug. 8, 2005

Related U.S. Application Data
(63) Continuation-in-part of application No. 10/735,781, filed on Dec. 16, 2003.

(51) Int. Cl. A61C 3/00

(52) U.S. Cl. 433/163

(57) ABSTRACT

A double-stick delivery pad for dental materials is attached to the gloved hand of a clinician. The delivery pad may serve as a holder for materials such as a prophylactic cleaning paste or as a releaseable retention service for small dental instruments in other accessories utilized in procedures other than cleaning. The adhesive pad can be used for presentation and delivery of dental restorative materials, bonding agents, resin sealants, orthodontic brackets, and other orthodontic hardware.

### RELATED APPLICATION

This patent application is a continuation-in-part of co-pending patent application Ser. No. 10/735,781 filed Dec. 16, 2003 for “Disposable Adhesive Delivery Pad for Dental Cleaning Pastes and Solutions,” priority from which is hereby claimed.

### FIELD OF THE INVENTION

The present invention relates to devices for hand-holding tooth preparation compounds in dentistry. More specifically, it relates to an article holding device which is adhesively attached to the dentist's or hygienist's glove.

### BACKGROUND OF THE INVENTION

In dentistry, a dental cleaning is called a prophylaxis and the cleaning paste is called prophylaxis paste. Such paste is most commonly provided in two ways: either in bulk in a large container from which one scoops out a portion with a spatula, or in individual dose cups. The paste is usually placed into a plastic or metal cup retainer attached to the dentist's or hygienist's gloved finger as it is being used. The individual dose cups are sometimes attached to the glove by an adhesive to retain the cup to the glove as shown for example in U.S. Pat. No. 4,988,296 to Spencer. U.S. Pat. No. 6,257,888 issued to Barham shows a tray-like holder for dental paste which also holds a dental instrument wiping medium. The tray is secured to the clinician's glove by an adhesive. U.S. Pat. Nos. 4,976,615 to Kravitz and 6,036,490 to Johnsen et al. disclose finger-mounted dental instrument delivery platforms. The platforms are secured to the finger by a clip. The problem with some of these systems of holding the working compound or dental devices is that the plastic or metal holders traditionally used require cleaning and sterilization.

### SUMMARY OF THE INVENTION

In order to solve the problems in the art described above, the present disposable adhesive pad has been devised. The invention comprises a foil sheet of semi-rigid laminated material which includes adhesive on portions of opposing top and bottom surfaces. On a portion of the top side an adhesive is covered by a peel-off label that preferably includes advertising. The remainder of the top surface is a substantially frictionless foil surface. The opposite bottom side is also provided with an adhesive on a portion of its surface. The foil is a medical metal foil that is insoluble in saliva, prophylactic paste, or water.

The device is substantially planar, however two wings may be formed along foldlines which provide sidewalls that extend upwardly from the top surface and contain the paste, holding it on the foil portion of the delivery pad. If the adjacent walled portion is used to contain the paste, it may be picked up by the rotating rubber cleaning cup as needed during the dental cleaning. When the top side label is peeled off, the adhesive underneath is available for placement of the dose cup type of prophylactic paste packaging. Once the cleaning is completed, the rubber glove is removed and the delivery pad discarded along with any residual paste.

The delivery pad of the invention also may serve as a releaseable retention surface for small dental instruments and other materials utilized in procedures other than cleaning. For example, the adhesive pad can also be used for presentation and delivery of dental restorative materials, bonding agents, resin sealants, orthodontic brackets, and other orthodontic hardware. It can also be used to hold porcelain veneers or other indirect dental restorations that need to be presented to the mouth for placement. It could also be useful in the specialty of prosthodontics and oral surgery when placing small attachments such as screws. Thus, the delivery pad may function as a service platform for compounds and solutions on the delivery portion foil area while functioning as a temporary holder for instruments and accessories on the adhesive portion.

Thus, the present invention provides a totally disposable device that offers a multitude of uses as a delivery service platform for the dentist. Advantages include clinical time-savings and the clinical convenience of having materials and small hand instruments directly accessible in the field of operation because there is less reaching and less passing of instruments between the dentist and assistant. The delivery pad of the invention follows the medical model for one-use-per-patient, eliminating cross-contamination and sterility problems and the low cost of manufacturing the device makes disposability practical. However, the chief advantage of the invention is that it makes for easier one-person operation. Other objects and advantages of the present invention will be readily apparent to those of skill in the art from the following drawings and description of the preferred embodiments.

### DESCRIPTION OF THE DRAWINGS

FIG. 1 is a front elevation view of a series of disposable pads positioned on a carrier strip. One pad is partially peeled back to expose the adhesive on the bottom side.

FIG. 2 is a top right front perspective view of a delivery pad of the invention.

FIG. 3 is a top right front perspective view with angled sidewalls folded upwardly.

FIG. 4 is a top left rear perspective view of the present invention placed on a gloved hand while in use.

FIG. 5 is a front view of the invention.

FIG. 6 is a front view of the invention with the label partially peeled from the top side of the delivery pad.

FIG. 7 is a top front isometric view of the invention alternately used to adhesively hold a prophylactic dose cup on the glove of the dental clinician or hygienist.

FIG. 8 is a top front isometric view of the invention alternately used to hold a dental material and adhesively secure a small dental instrument.

FIG. 9 is a top front isometric view showing the dental instrument released from the adhesive holding portion of the delivery pad and being manually applied to the contained dental material.

### DESCRIPTION OF THE PREFERRED EMBODIMENT

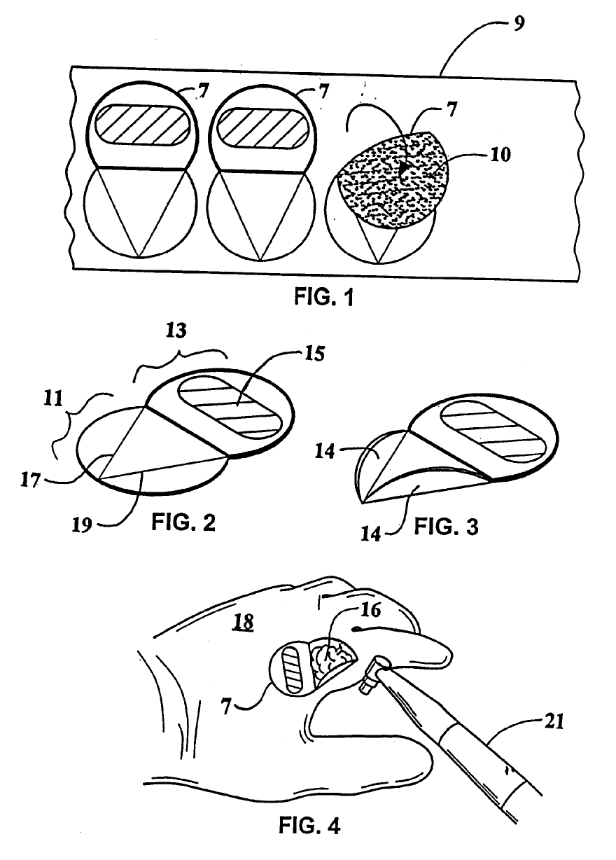

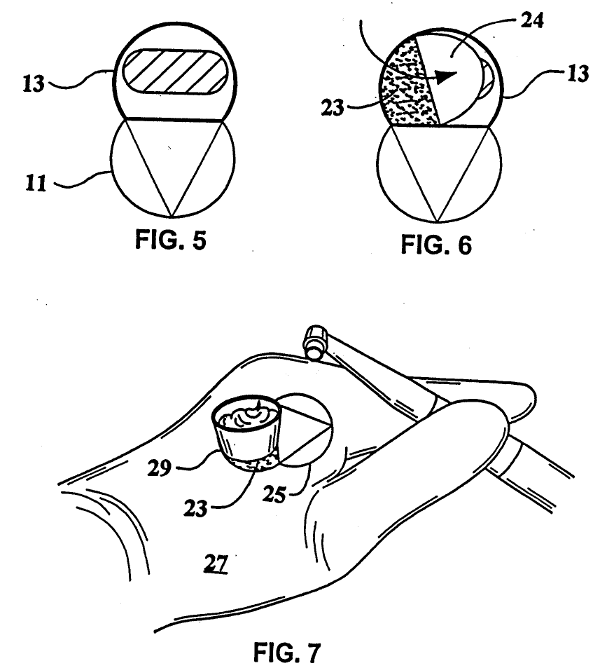

Referring now to FIG. 1, the present invention is shown in its bulk manufactured state comprising a plurality of delivery pads 7 adhesively held on the manufacturing carrier strip 9. Because the invention is comprised of several adhesively laminated paper components, it may be produced inexpensively by label manufacturing equipment. Each individual delivery pad may be peeled off the carrier strip as it is needed just before use. The pad farthest to the right in FIG. 1 reveals an adhesive 10 on the bottom side of the pad, which after removal from the carrier strip, is immediately pressed against the hand or clinician's glove to hold the pad in place as shown in FIG. 4 below. The bottom side adhesive material does not cover the undersides of the fold-up wings 14 but covers the rest of the underside to provide firm attachment to the glove. As an alternative to coverage by a carrier strip, the bottom of individual pads may have a separate peel-off cover.

Referring now to FIG. 2, the delivery pad of the invention includes two main portions, a containment or delivery portion 11 and an attachment portion 13. The attachment portion includes a top side adhesive covered by a releasable paper label that preferably includes advertising 15. Scored foldlines 17 and 19 on the delivery portion allow sides of the delivery pad to fold upwardly to provide containment sidewalls 14 for a dental paste or other working material as shown in FIG. 3. The top side label and the peel-off bottom cover may include a tab or portion along the edge that is not secured by adhesive to facilitate grasping and removal.

Referring now to FIG. 4, the delivery pad 7 is shown attached to the glove 18 of the clinician with the sidewall wings folded upwardly to create a containment pocket on the delivery portion so that the paste 16 may be scooped in the usual fashion with the rubber cleaning cup of the clinician's handpiece 21. A metal foil provides an ideal surface of reduced friction to adequately hold the paste yet permits its easy removal. The foil material is preferably of the type such as 7 pt. 5 silver foil laminated board produced by the Fasson Roll North America, a division of Avery Dennison.

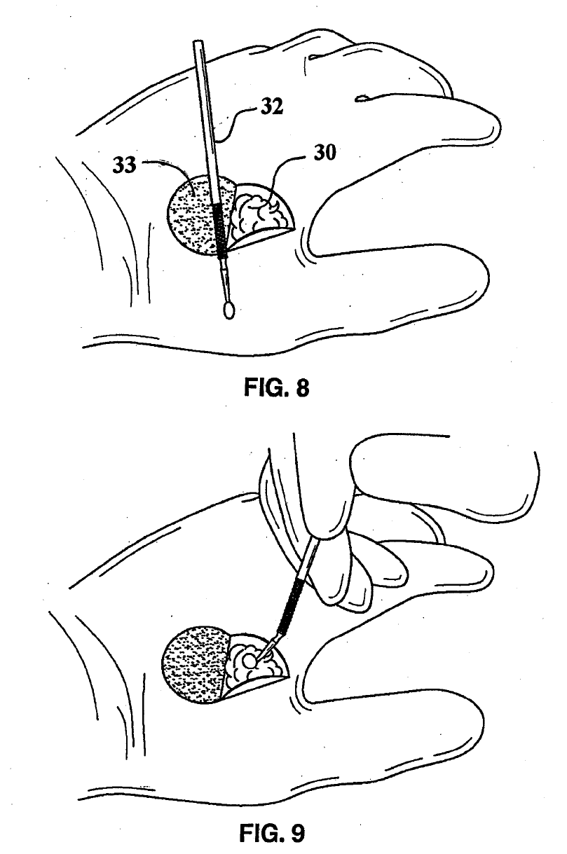

Referring now to FIGS. 5, 6, and 7, the present invention is shown in a different application. As shown in FIG. 5, the invention is identical having a delivery portion 11 and attachment portion 13 except that as illustrated in FIG. 6, the top paper cover 24 of the attachment portion 13 of the label is removed to reveal an adhesive layer 23 underneath. The result is a foil substrate with adhesive on both sides. When in use as shown in FIG. 7, one side holds the foil board 25 to the glove 27 while the top side may be used to hold a dose cup 29 for prophylactic paste or other dental material thus securing the cup to the glove. In this application, the delivery pad is not used but it provides a second utility for the invention if the clinician desires to use a dose cup.

The present device may serve other uses and may provide a disposable adhesive delivery pad for application of other dental materials. For example, as shown in FIGS. 8 and 9, the dentist or hygienist is shown applying a bonded resin sealant to a tooth. A portion of liquid resin 30 could be carried on the non-adhesive section of the delivery pad for pick-up by a microbrush applicator 32. The adhesive section of the top of the pad 33 can be exposed to serve as a releasable attachment mechanism to secure the applicator 32 at times when not needed. This is exceptionally helpful when a procedure is being performed by a sole operator, who has no assistant from whom to receive materials or instruments. Another practical example which would provide such a convenience would be when an orthodontic assistant who has the chore of bonding many orthodontic brackets to teeth using light-cured resin material. The delivery pad of the invention therefore serves as not only a holder for dental pastes and solutions but also as a temporary holder for small dental instruments and other loose hardware, implements, or articles.

From the foregoing, it will be readily understood by those of skill in the art that the present invention provides both a disposable dental paste delivery system for bulk dental pastes or other dental materials and also a convenient means of attachment of material packaged in the form of a dose cup. The non-adhesive portion of the pad may also be used to serve as a delivery point for various types of dental materials such as dental cements, resin restorative materials, or even medicaments that need to be applied to structures in the mouth. Furthermore, as mentioned above, the adhesive portion of the top surface of the pad may be used to temporarily secure a small applicator brush or instrument or provide a surface for attachment of any small item that the dentist or hygienist may need to complete a dental procedure.

Because it can be inexpensively produced by label-printing manufacturing methods, the addition of printed advertising on the top cover of the attachment portion may be inexpensively included as an additional benefit. Also, although the preferred embodiment shows the use of two upwardly folded angled sidewalls, it will be understood that a greater number of sidewalls formed along additional foldlines may similarly be employed to contain the working material. It should be understood that there may be other modifications and changes to the present invention that will be obvious to those of skill in the art from the foregoing description, however, the present invention should be limited only by the following claims and their legal equivalents.

1. A dental material delivery pad for adhesive attachment to a hand or glove, comprising:
a planar delivery pad having a delivery portion and an attachment portion, a top surface and a bottom surface;
a containment pocket on the top surface of the delivery portion of said pad for containment of dental material; and
wherein the top surface of the attachment portion of said pad further includes an adhesive adapted to releasably receive at least one implement for a dental procedure.

2. The delivery pad of claim 1 further including an adhesive on the bottom surface of the attachment portion of said pad.

3. The delivery pad of claim 2 further including a peel-off label covering the adhesive on the top portion of said pad.

4. The delivery pad of claim 3 wherein said peel-off label further includes printed advertising.

5. The delivery pad of claim 4 further including a plurality of foldlines on the top surface of the delivery portion of said pad for forming sidewall portions of said pad, said sidewalls being upwardly foldable along said foldlines for forming said containment pocket.

6. The delivery pad of claim 5 wherein said foldlines are convergent to a point on the edge of the pad in the direction extending away from said attachment portion.

7. An arrangement of dental material delivery pads comprising a plurality of delivery pads as described in claim 2, said pads being arranged in a row and each individually adhesively affixed to a carrier strip.

8. The dental material delivery pad of claim 1 wherein said dental material is from the group consisting of a cleaning paste, a bonding agent, and a restorative material.

9. The delivery pad of claim 6 wherein said dental material is a liquid sealant.

10. The dental material delivery pad of claim 1 wherein said implement is an applicator brush.

11. The dental material delivery pad of claim 6 wherein said at least one implement is from the group consisting of orthodontic hardware, porcelain veneers, root canal instruments, and small attachments such as screws.

12. The dental material delivery pad of claim 1 wherein said pad comprises a paper board laminated with metal foil.

13. The dental material delivery pad of claim 2 wherein the bottom surface includes a peel-off cover.

14. A dental material delivery pad for adhesive attachment to a hand or glove, comprising:
a planar delivery pad having a delivery portion and an attachment portion, a top surface and a bottom surface;
an adhesive on the bottom surface of the attachment portion of said pad; and
a plurality of foldlines on the top surface of the delivery portion of said pad for forming sidewall portions of said pad, said sidewalls being upwardly foldable along said foldlines for facilitating the containment of dental material on said delivery portion of said pad.
